(19) United States
(12) Patent Application Publication
(10) Pub. No.: US 2005/0046345 A1
(43) Pub. Date: Mar. 3, 2005

(54) Organic electroluminescent display with porous material layer

(76) Inventor: Jin-Woo Park, Yongin-si (KR)

Correspondence Address: Robert E. Bushnell;Suite 300, 1522 K Street, N.W., Washington, DC, 20005, US

(21) Appl. No.: 10/920,243

(22) Filed: Aug. 18, 2004

(30) Foreign Application Priority Data
Aug. 28, 2003 (KR) 2003-59903

(51) Int. Cl. H05B 33/00

(52) U.S. Cl. 313/506

(57) ABSTRACT

An organic electroluminescent display includes: first and second substrates arranged opposite to each other and combined together, an organic electroluminescent unit disposed between the first and second substrates and having a pair of opposing electrodes and an organic emissive layer adapted to emit light by a recombination of electrons and holes supplied by the pair of electrodes, a porous material layer disposed between the first and second substrates and adapted to absorb moisture, the porous material layer including a number of absorption holes and a porous material adapted to remain transparent after absorption of moisture. A color filter can be interposed between the first and second substrates.

### CLAIM OF PRIORITY AND CROSS-REFERENCE TO RELATED APPLICATIONS

This application makes reference to, incorporates the same herein, and claims all benefits accruing under 35 U.S.C. §119 from an application for ORGANIC ELECTROLUMINESCENT DISPLAY WITH POROUS MATERIAL LAYER earlier filed in the Korean Intellectual property Office on 28^{th} Aug. 2003 and there duly assigned Serial No. 2003-59903.

Furthermore, the present application is related to co-pending U.S. application Ser. No. to be assigned, filed concurrently with this application and entitled: ORGANIC ELECTROLUMINESCENT DISPLAY WITH POROUS MATERIAL LAYER. The related application bears common inventorship with this application and claims priority under 35 U.S.C. §119 from an application for ORGANIC ELECTROLUMINESCENT DISPLAY WITH POROUS MATERIAL LAYER earlier filed in the Korean Intellectual property Office on 27^{th} Aug. 2003 and there duly assigned Serial No. 2003-59489.

### BACKGROUND OF THE INVENTION

1. Field of the Invention

The present invention relates to an organic electroluminescent display, and more particularly, the present invention relates to an organic electroluminescent display having an improved sealing structure.

2. Description of the Related Art

In general, Organic Electroluminescent Displays (OELDs) are self-luminous displays operating at a low voltage by electrically exciting a fluorescent organic compound to emit light. Since OELDs can be made thin, have a wide viewing angle, and have a rapid response rate, they are receiving great attention as a next generation display, eliminating problems arising with liquid crystal displays.

Such an organic electroluminescent display is manufactured by forming an organic layer in a predetermined pattern on a transparent insulating substrate, such as glass, and then forming electrode layers on the top and bottom surfaces thereof. In this organic electroluminescent display, holes injected from anodes migrate toward an emissive layer when an anode voltage is applied to the anode, and electrons injected from cathodes migrate toward the emissive layer when a cathode voltage is applied to the cathode, so that the holes and electrons recombine in the emissive layer to generate exitons. As these exitons transit from an exited state to a base state, luminescent molecules in the emissive layer emit light, thereby forming images.

Organic electroluminescent displays deteriorate as moisture intrudes thereinto, so that a sealing structure for preventing intrusion of moisture is required.

Conventionally, a sealing structure has been used which consists of a metal can or glass substrate formed into a cap having grooves filled with a desiccant powder. In addition, a film desiccant has been attached using double-sided tape. The use of a desiccant powder complicates manufacturing processes, raises material and manufacturing costs, and increases the thickness of the substrate. Furthermore, due to the area filled with the desiccant powder, front emission or double-sided emission, particularly when used together with a non-transparent substrate, cannot be achieved. The film desiccant is not a perfect sealing structure preventing intrusion of moisture and is liable to be damaged in the manufacture or when used due to its poor durability and reliability. Therefore, the film desiccant is not suitable for use on a mass scale.

U.S. Pat. No. 5,882,761 relates to an organic electroluminescent display apparatus including a stack of pairs of opposing electrodes with an emissive layer made of an organic compound therebetween, a container sealing the stack from external air, and a desiccant placed inside the container, wherein the desiccant remains in a solid state even after absorbing moisture. This patent suggests the use of an alkali metal oxide, sulfate, etc. as the desiccant. However, the organic electroluminescent display is thick due to the container. Furthermore, the desiccant becomes opaque, although it remains as a solid, after absorbing moisture, so that it cannot be applied to front emission and double-sided emission displays. As described above, the manufacture of the organic electroluminescent display apparatus is complicated, and the material and manufacturing costs are high.

Japanese Laid-Open Patent Publication No. 5-335080 relates to a method of forming a protective layer in a thin, organic electroluminescent display including an emissive layer containing at least one kind of organic compound arranged between an anode and a cathode, at least one of which is transparent, the protective layer being made of amorphous silica. In particular, amorphous silica, which has a dense structure, is applied as a thick layer to a second electrode layer to prevent intrusion of moisture from the outside. However, the amorphous silica protective layer cannot absorb moisture present in the electroluminescent display, and accordingly, an additional moisture absorbing material is required.

### SUMMARY OF THE INVENTION

The present invention provides an organic electroluminescent display (OELD) capable of front emission or double-sided emission because it remains transparent even when moisture is absorbed and capable of easily achieving full color display.

The present invention provides an OELD with a simple protective structure that prevents an organic emissive layer from deteriorating due to moisture, thus extending the life span of the display.

According to an aspect of the present invention, an organic electroluminescent display is provided comprising; first and second substrates arranged opposite to each other and combined together; an organic electroluminescent unit arranged between the first and second substrates and having a pair of opposing electrodes and an organic emissive layer adapted to emit light due to a recombination of electrons and holes supplied by the pair of opposing electrodes; a porous material layer disposed between the first and second substrates and adapted to absorb moisture, the porous material layer including a plurality of absorption holes and a porous material adapted to remain transparent after absorption of moisture.

A color filter can preferably be interposed between the first and second substrates.

The porous material layer can preferably be arranged on a surface of the second substrate opposite to the first substrate.

The color filter can preferably be arranged on a surface of the porous material layer opposite to the first substrate.

The color filter can preferably be arranged on a surface of the second substrate opposite to the first substrate.

The porous material layer can preferably be arranged on a surface of the color filter opposite to the first substrate.

The porous material layer can preferably have a thickness ranging from 100 nm to 15 μm.

The absorption holes of the porous material layer can preferably have a diameter ranging from 0.5 nm to 100 nm.

An area of the porous material layer can preferably be equal to or greater than that of the organic electroluminescent unit.

The second substrate can preferably comprise a glass substrate or a transparent plastic substrate.

The organic electroluminescent display can preferably further comprise a waterproof protective layer arranged on an internal surface of the plastic substrate.

At least one of the opposing electrodes of the organic electroluminescent unit, arranged to face the second substrate, can preferably include a transparent conducting agent.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a sectional view of an organic electroluminescent display (OELD) according to an embodiment of the present invention;

FIG. 2 is a partial sectional view of a second substrate shown in FIG. 1;

FIG. 3 is a perspective view of a porous material layer used in an OELD according to the present invention;

FIG. 4 is a sectional view of an OELD according to another embodiment of the present invention; and

FIG. 5 is a sectional view of an OELD according to yet another embodiment of the present invention.

### DETAILED DESCRIPTION OF THE INVENTION

Embodiments of an organic electroluminescent display (OELD) according to the present invention will be described with reference to the appended drawings.

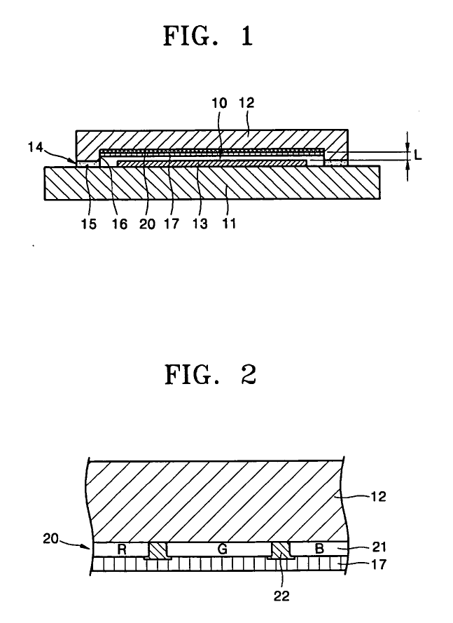

Referring to FIG. 1, an OELD according to an embodiment of the present invention includes a first substrate 11 and a second substrate 12, which are made of insulating materials and are disposed opposite to each other, and an organic electroluminescent (OEL) unit 13 disposed between the first substrate 11 and the second substrate 12 and having a plurality of pixels to form predetermined images. The first substrate 11 and the second substrate 12 are combined together using a sealing portion, described later, to seal at least the OEL unit 13.

The first substrate 11 can be made of a transparent insulating material, such as glass or a transparent plastic. The second substrate 12, which is a sealing portion combined with the first substrate 11, as illustrated in FIG. 1, can be an insulating substrate. In a rear emission display, which displays images on the first substrate 11, the second substrate 12 can be implemented with any opaque element, such as a substrate or a metal cap. In a front emission display, which displays images on the second substrate 12, or in a double-sided emission display, which displays images on both the first and second substrates 11 and 12, the second substrate 12 can be made of a transparent glass or a transparent plastic. When the second substrate 12 is made of a plastic substrate, a waterproof protective layer (not shown) can be formed on an internal surface of the second substrate 12 to protect the OEL unit 13 from moisture. The protective layer can be made to be resistant to heat and chemicals.

The OEL unit 13, which includes a plurality of pixels to display predetermined images, is formed on the first substrate 11. The OEL unit 13 can be formed on the second substrate 12.

Although not illustrated, the OEL unit 13 includes a pair of opposing electrodes, and at least one organic emissive layer arranged between the pair of electrodes. The OEL unit 13 can be either a passive matrix OEL or an active matrix OEL, which are classifications according to driving methods.

As described above, the OEL unit 13, regardless of being a passive matrix OEL or an active matrix OEL, includes an anode acting as a hole source and a cathode acting as an electron source, which are disposed opposite to each other, and an organic emissive layer. The anode is positioned closer to the first substrate 11 than the cathode. The organic emissive layer and the cathode are sequentially formed on the anode. This structure of the OEL unit 13 is for illustrative purposes only and the present invention is not limited thereto. Alternatively, the positions of the anode and the cathode can be shifted. When the OEL unit 13 is an active matrix OEL, the OEL unit 13 can further include a thin film transistor (TFT) layer underlying the anode. This TFT layer is connected to the anode and can include at least one TFT and a capacitor.

The anode can be made of a transparent electrode, such as an Indium Tin Oxide (ITO) electrode. In a rear emission display, which emits light toward the first substrate 11, the cathode can be made of a reflective material, such as a mixture of Al and/or Ca. In a front emission display, which emits light toward the second substrate 12, or a double-sided emission display, which emits light toward both the first substrate 11 and the second substrate 12, the cathode can be formed to be transparent by forming a semi-transmissive thin layer using a metal, such as Mg and/or Ag and depositing a transparent ITO or IZO layer thereon. In the rear emission display, an electrode closer to the first substrate 11 is formed as a transparent electrode whereas an electrode closer to the second substrate 12 is formed as a reflective electrode. In the front emission display, an electrode closer to the first substrate 11 is formed as a reflective electrode whereas an electrode closer to the second substrate 12 is formed as a transparent electrode.

The anode and the cathode can each be formed in a predetermined pattern. In an active matrix display, the cathode can be formed as an entire layer and can also be formed in a pattern.

A low molecular weight organic layer or a high molecular weight organic layer can be formed as the organic layer interposed between the anode and the cathode. Alternatively, when a low molecular weight organic layer is used, it can be formed as a hole injection layer (HIL), a hole transport layer (HTL), an organic emission layer (EML), an electron injection layer (EIL), or an electron transport layer (ETL), having a single layered structure or a stacked composite structure. Various organic materials, for example, copper phthalocyanine (CuPc), (N,N′-di(naphthalene-1-yl)-N,N′-diphenyl-benzidine (NPB), and tris-8-hydroxyquinoline aluminum (Alq3), can be used. The low molecular weight organic layer can be formed using vacuum deposition.

When a high molecular weight organic layer is used, it can include a HTL and an EML. In this case, the HTL is made of PEDOT, and the EML is made of a high molecular weight organic material, such as polyphenylenevinylenes (PPVs) and polyflorenes. The high molecular weight organic layer can be formed using screen printing or inkjet printing.

In the OEL unit 13, as an anode voltage is applied to the anode and a cathode voltage is applied to the cathode, holes injected from the anode migrate into the emissive layer, and electrons migrates from the cathode into the emissive layer so that exitons are generated by recombination of the holes and the electrons in the emissive layer. As the exitons transit from an excited state to a base state, fluorescent molecules in the emissive layer emit light, forming images.

In addition, an insulating protective layer (not shown), which can cover a top surface of the OEL unit 13, can be formed on an upper electrode of the OEL unit 13, which faces the second substrate 12, to provide resistance to heat, chemicals, and moisture intrusion. The protective layer can be made of a metal oxide or a metal nitride.

A space region 10 between the first substrate 11 and the second substrate 12 can be evacuated or filled with an inert gas, such as neon or argon. Alternatively, the space region 10 can be filled with a liquid having the same function as the inert gas.

A sealing portion 14 by which the first substrate 11 and the second substrate 12 are combined together is formed using a sealant 15. Any sealant that can combine substrates together, for example, UV curable adhesives or thermally curable adhesives, can be used as the sealant 15.

Although not illustrated in FIG. 1, interconnect wires, circuits, and terminals which are electrically connected to the electrodes of the OEL unit 13, are drawn out of the sealing portion 14, so that the OEL unit 13 can be driven.

According to the present invention, a porous material layer 17, which can absorb moisture, and a color filter 20 can be further disposed in the space region 10 between the first and second substrate 11 and 12.

In the embodiment of the OELD according to the present invention, illustrated in FIGS. 1 and 2, the color filter 20 is formed on a surface of the second substrate 12 opposite to the first substrate 11, and the porous material layer 17 is formed on the color filter 20. However, the present invention is not limited to this structure. For example, although not illustrated in the drawings, the porous material layer 17 can be formed on the surface of the second substrate 12 opposite to the first substrate 11, and the color filter 20 can be formed on the porous material layer 17. Alternatively, the porous material layer 17 can be formed only on the second substrate 12, and the color filter 20 can be formed on the first substrate 11. In this case, the color filter 20 can be on a top surface of the first substrate 11 toward the space region 10 or inside the OEL unit 13.

As shown in FIG. 2, the color filter 20 can include a pixel filter layer 21 including red (R), green (G), and blue (B) patterns, which are positioned corresponding to pixels of the OEL unit 13, and a black material layer 22 interposed between each of the R, G, B patterns of the pixel filter layer 21.

According to the present invention, since a full color display can be achieved by the color filter 20, the OEL unit 13 can be configured to emit only white light.

The porous material layer 17 disposed on a top surface of the color filter 20, i.e., opposite to the first substrate 11, is made of a transparent material. The porous material layer 17 can absorb moisture in the space region 10 between the first and second substrates 11 and 12. The porous material layer 17 remains transparent after moisture absorption.

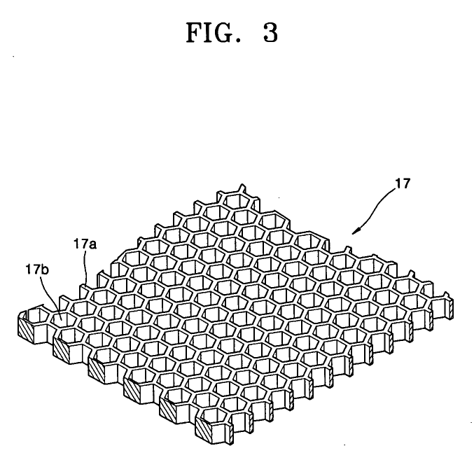

The porous material layer 17, which remains transparent even after moisture absorption, can be made of a porous oxide including a number of absorption holes 17b, as illustrated in FIG. 3.

Referring to FIG. 3, the porous material layer 17 made of a porous oxide includes a frame 17a and a number of absorption holes 17b. The frame 17a serves as a building block forming the structure of the porous material layer 17, and the absorption holes 17b capture moisture therein. Due to this structure, the porous material layer 17 can be transparent before and after moisture absorption, as described above.

Examples of the porous oxide that can be used for the porous material layer 17 can be porous silica; hydrated amorphous alumina; a binary compound of porous silica and hydrated amorphous alumina; a binary or higher compound including hydrated amorphous alumina and at least one of alkali metal oxide, alkali earth metal oxide, a metal halogen compound, metal sulfate, and metal perchlorinate; and a ternary or higher, multi-compound including hydrated amorphous alumina, silica, and at least one of hydrated amorphous alumina and at least one of alkali metal oxide, alkali earth metal oxide, a metal halogen compound, metal sulfate, and metal perchlorinate.

When using a porous oxide which is a binary compound including hydrated amorphous alumina and porous silica, the porous material layer 17 can have a dual-layered structure including an alumina layer and a silica layer.

According to the present invention, at least one of alkali metal oxide, alkali earth metal oxide, a metal halogen compound, metal sulfate, and metal perchlorinate is captured within an alumina network or an alumina-silica network.

When forming the porous material layer 17 using hydrated amorphous alumina and silica, the hydrated amorphous alumina and the silica can be mixed in, but not limited to, a ratio of 0.01:1-1:1.

Examples of hydrated amorphous alumina include bohemite (AlOOH) and byerite (Al(OH)₃), which are monohydrated alumina.

Examples of the alkali metal oxide include lithium oxide (Li₂O), sodium oxide (Na₂O), and potassium oxide(K₂O). Examples of the alkali earth metal oxide include barium oxide (BaO), calcium oxide (CaO), and magnesium oxide (MgO). Examples of the metal sulfate include lithium sulfate (Li₂SO₄), sodium sulfate (Nai₂SO₄), calcium sulfate (CaSO₄), magnesium sulfate (MgSO₄), cobalt sulfate (CoSO₄), gallium sulfate (Ga₂(SO₄)₃), titanium sulfate (Ti(SO₄)₂), and nickel sulfate (NiSO₄). Examples of the metal halogen compound include calcium chloride (CaCl₂), magnesium chloride (MgCl₂), strontium chloride (SrCl₂), yttrium chloride (YCl₂), copper chloride (CuCl₂), cerium fluoride (CsF), tantalum fluoride (TaF₅), niobium fluoride (NbF₅), lithium bromide (LiBr), calcium bromide (CaBr₃), cerium bromide (CeBr₄), selenium bromide (SeBr₂), vanadium bromide (VBr₂), magnesium bromide (MgBr₂), barium iodide (BaI₂), and magnesium iodide (MgI₂). Examples of the metal perchlorinate include barium perchlorinate (Ba(ClO₄)₂) and magnesium perchlorinate (Mg(ClO₄)₂).

The porous material layer 17 can be formed using porous silica by applying a variety of methods, one of which is as follows.

First, a first mixture is prepared by mixing 0.3 g of a surfactant and 0.6 g of a solvent. A polymeric surfactant is used, and a 1:2 mixture of propanol and butanol is used as the solvent. Next, a second mixture is prepared by mixing 5 g of tetraethyl orthosilicate (TEOS) and 10.65 g of a solvent, and 1.85 g of HCL.

After stirring the second mixture for about 1 hour, 2.1 g of the second mixture is mixed with the first mixture to obtain a third mixture. This third mixture is coated on the second substrate 12 with the color filter 20 using spin coating, spray coating, roll coating, etc. As an example, the third mixture can be spin-coated on the second substrate 12 with the color filter 20 at 2000 rpm for about 30 seconds. The resulting structure is aged at room temperature for 24 hours or at 40-60° C. for 5 hours and calcinated in an oven at 400° C. for about 2 hours to burn off the polymer and to form absorption holes. As a result, a porous silica layer having a thickness of 7000 Å is formed. The above processes are repeated until a porous layer having a desired thickness is formed. The amounts of the materials used to form the porous layer are not absolute. Rather, the ratio of the materials should be fixed.

In another method, ammonia water (NH₄OH) is added to 30 g of H₂O to provide alkalinity. 10 g of TEOS is added to the alkaline solution and heated for 3 hours or longer while stirring it for hydrolysis and polycondensation reactions. An acid, which can be organic or inorganic, is added to the resulting solution.

Next, 13.2 g of a water-soluble acrylic resin solution (30% by weight) is added to stabilize the resulting mixture and stirred to obtain a homogeneous solution.

This solution is spin-coated on the second substrate 12 with the color filter 20 at 180 rpm for 120 seconds and dried in a drying oven for about 2 minutes to remove the remaining unvaporized solvent. These processes are repeated to form a thicker porous layer.

Polymeric and organic substances are removed from the resulting structure and thermally treated at 500° C. for 30 minutes to harden the silica. The amounts of the materials used to form the porous layer are not absolute. Rather, the ratio of the materials should be fixed.

The porous silica layer formed using one of the above-described methods include absorption holes 17b in its structure, as illustrated in FIG. 3. The size of the absorption holes 17b can be in a range of 2-30 nm. The size of the absorption holes 17b can be varied by adjusting the molecular weight of the polymer used in the first mixture. The absorption holes 17b can occupy about 80% of the volume of the porous silica layer. As described above, the porous silica layer can be formed using spin coating, spray coating, roll coating, etc. The porous silica layer is mechanically and thermally stable. The porous silica layer can be manufactured using processes which are easy to control.

When using hydrated amorphous alumina, a porous oxide layer according to the present invention can be formed by coating and drying an alumina solution prepared by thermally processing a composition containing aluminum alkoxide and a polar solvent. The alumina solution can be coated using, but not limited to, spin coating, screen printing, etc. Examples of aluminum alkoxide that can be used include aluminum triisoproxide (Al(OPr)₃), aluminum tributoxide (Al(OBu)₃), etc. The polar solvent can be at least one of pure water, ethanol, methanol, butanol, isopropanol, and methylethylketone.

A hydrolytic catalyst, such as nitric acid, hydrochloric acid, phosphoric acid, sulfuric acid, etc., can be further added to the composition. Alternatively, polyvinyl alcohol, an antifoaming agent, etc., can be further added to the alumina solution if required. A detailed method of forming a porous oxide layer using hydrated amorphous alumina is as follows.

300 g of H2O is heated to 80° C., and 165.54 g of Al(OPr)₃ is added thereto and stirred for 20 minutes. 1.2 g of 30% hydrochloric acid (HCl) is added to the reaction mixture and heated to 95° C. and refluxed for 3 hours to obtain a transparent alumina solution.

60 g of H₂O is added to 25 g of the transparent alumina solution and stirred for 20 minutes. 10 g of a 30% aqueous polyvinyl alcohol (PVA) solution (by weight, having a weight average molecular weight of 20,000) is added to the mixture and stirred for 20 minutes, and 5 g of an antifoaming agent is added to prepare a coating solution for a porous alumina layer.

The coating solution is spin-coated on the second substrate 12 with the color filter 20 at 180 rpm for 120 seconds and dried in a drying oven for about 2 minutes to remove the remaining unvaporized solvent. The resulting structure is thermally processed to form a porous alumina layer. These processes are repeated to form a thicker porous alumina layer. The amounts of the materials used to form the porous alumina layer are not absolute. Rather, the ratio of the materials should be fixed.

A method of manufacturing a porous material layer according to the present invention using a mixture of porous silica and hydrated amorphous silica is as follows.

As described above, a silica-forming composition containing silicon alkoxide and a polar solvent is added to an alumina solution prepared as described above. A porous oxide layer containing a mixture of alumina and silica can be formed from the mixture of the silica-forming composition and the alumina solution.

The silicon alkoxide used in the present invention has formula (1) below. Examples of the silicon alkoxide include tetraethyl orthosilicate (TEOS), etc. 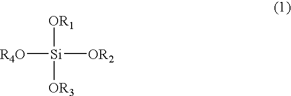
where each of R₁, R₂, R₃, and R₄ is independently a C₁-C₂₀ alkyl group or a C₁-C₂₀ or a C₆-C₂₀ alkyl group.

The polar solvent can be at least one of ethanol, methanol, butanol, isopropanol, methylethylketone, and pure water, as used in the preparation of the alumina solution. In addition, a hydrolytic catalyst, such as nitric acid, hydrochloric acid, phosphoric acid, sulfuric acid, etc., can be further added.

In particular, 10 g of TEOS is added to 30 g of H₂O and 10 g of EtOH and stirred for 30 minutes or longer for hydrolysis reaction. CaCl₂ is added to the reaction product and dissolved to obtain a composition for a porous silica layer.

The resulting composition is spin-coated on the second substrate 12 with the color filter 20 at 180 rpm for 120 seconds and dried in a drying oven for about 2 minutes to remove the remaining unvaporized solvent. The resulting structure is thermally processed to form a composite porous oxide layer.

A method of forming a porous material layer having a structure in which at least one of alkali metal oxide, alkali earth metal oxide, a metal halogen compound, metal sulfate, and metal perchlorinate is captured in a porous hydrated amorphous alumina network is as follows.

A composition containing aluminum alkoxide and a polar solvent is coated on a surface of a substrate to be used as the sealing member 13 and thermally treated to form a porous oxide layer. As a result of hydrolysis and dehydrated polycondensation reactions, a porous alumina layer is formed.

The thermal treatment can be performed at 100-550° C. If the temperature is lower than 100° C., an organic substance such as solvent can remain within the layer. If the temperature is higher than 550° C., the glass substrate itself can deform.

The alumina forming composition can be coated using various methods, for example, but not limited to, spin coating, screen printing, etc.

Examples of the aluminum alkoxide that can be used include aluminum triisoproxide (Al(OPr)₃), aluminum tributoxide (Al(OBu)₃), etc. The polar solvent can be at least one of pure water, ethanol, methanol, butanol, isopropanol, and methylethylketone. The amount of the polar solvent can be in a range of 100-1000 parts by weight based on 100 parts by weight of aluminum alkoxide.

A hydrolytic catalyst, such as nitric acid, hydrochloric acid, phosphoric acid, sulfuric acid, etc., can be further added to the composition. The amount of the hydrolytic catalyst can be in a range of 0.1-0.9 moles based on 1 mole of aluminum alkoxide.

An additive, such as polyvinyl alcohol, polyvinyl pyrrolidone, polyvinyl butyral, etc. can be further added to the composition if required. Polyvinyl alcohol, polyvinyl pyrrolidone, and polyvinyl butyral improve porosity and coating property. The amount of the additive can be in a range of 1-50 parts by weight based on 100 parts by weight of aluminum alkoxide. A polyvinyl alcohol, a polyvinyl pyrrolidone, and a polyvinyl butyral having a weight average molecular weight of 5,000-300,000 can be used.

The alumina composition can further include at least one an alkali metal salt, an alkali earth metal salt, a metal halogen compound, a metal sulfate, and a metal perchlorinate. The amount of the alkali metal salt or the alkali earth metal salt can be in a range of 0.1-0.5 moles based on 1 mole of aluminum alkoxide.

When adding an alkali metal salt and/or an alkali earth metal salt to the composition, a porous oxide layer having a structure in which moisture-absorptive alkali metal oxide and/or alkali metal oxide is captured in a porous alumina is formed. The porous oxide layer having this structure has greater moisture absorbance than a porous oxide layer containing only porous alumina.

Examples of the alkali metal salt, which is a precursor of alkali metal oxide, include sodium acetate, sodium nitrate, potassium acetate, and potassium nitrate. Examples of the alkali earth metal salt include calcium acetate, calcium nitrate, barium acetate, barium nitrate, etc. The above-listed examples of the metal halogen compound, metal sulfate, and metal perchlorinate can be used.

A silica composition including silicon alkoxide and a polar solvent can be added to the alumina composition. When adding the silica composition to the alumina composition, a porous oxide layer containing a mixture of alumina and silica is finally formed.

As in the preparation of the alumina solution, the polar solvent can be at least one of ethanol, methanol, butanol, isopropanol, methylethylketone, and pure water. The amount of the polar solvent can be in a range of 100-1000 parts by weight based on 100 parts by weight of the silicon alkoxide.

A hydrolytic catalyst, such as nitric acid, hydrochloric acid, phosphoric acid, sulfuric acid, etc., can be further added to the composition. The amount of the hydrolytic catalyst can be in a range of 0.1-0.9 moles based on 1 mole of aluminum alkoxide. If the amount of the hydrolytic catalyst is less than 0.1 moles, the manufacturing time increases. If the amount of the hydrolytic catalyst is greater than 0.9 moles, it is difficult to control the manufacturing process.

The porous material layer 17, manufactured using one of the above-described methods, can have a thickness of 100 nm-50 μm. If the thickness of the porous material layer 17 is less than 100 nm, the porous material layer 17 cannot absorb moisture sufficiently to protect the OEL unit 13 from moisture. If the thickness of the porous material layer 17 is greater than 50 μm, it takes too much time to manufacture, thus lowering productivity.

The porous material layer 17 is formed so as not to contact the sealing portion 14. If the porous material layer 17 contacts an area where the sealant 15 is applied to form the sealing portion 14, the adhesion of the sealant 15 can decrease. By preventing adhesion deterioration to the sealing portion 14, moisture intrusion into the space region 10 can be prevented and the OEL unit 13 can be effectively protected from external impact.

According to the present invention, to prevent adhesion deterioration of the sealant 15, the porous material layer 17 does not extend to the sealing portion 14. The porous material layer 17 can be larger than the OEL unit 13 for a greater moisture absorption area.

To prevent the porous material layer 17 from contacting the sealing portion 14, as shown in FIG. 1, an internal surface of the second substrate 12 opposite to the OEL unit 13 is recessed.

Corners of a recessed portion 16 can have right angles or be rounded although not illustrated. By forming at least one of the color filter 20 and the porous material layer 17 within the recessed portion 16, adhesion deterioration of the sealing portion 14 can be prevented.

Furthermore, when using the second substrate 12 with the recessed portion 16 in a front emission display emitting light toward the second substrate 12 or in a double-sided emission display, a Moire phenomenon in the space region 10 can be prevented. The Moire phenomenon can occur in a front emission or double-sided emission display, due to light interference, when a distance between the first and second substrates 11 and 12, particularly, a distance L between the OEL unit 13 and the porous material layer 17 in the space region 10, is as small as a few micrometers. However, when using the second substrate 12 with the recessed portion 16, the distance L between the OEL unit 13 and the porous material layer 17 in the space region 10 is large enough to prevent the Moire phenomenon.

The recessed portion 16 can have a depth of about 3-400 μm from a portion of the second substrate 12 with the sealing portion 14. When a glass substrate is used as the second substrate 12, the recessed portion 16 can be formed using etching.

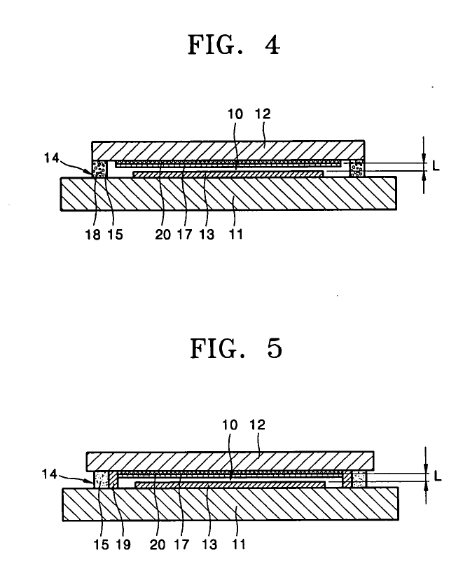

The above-described effects can be achieved by an OELD according to another embodiment of the present invention illustrated in FIG. 4. In particular, a porous material layer 17 made of porous oxide, which remains transparent after moisture absorption, is formed on an internal surface of the second substrate 12 with the color filter 20 and spaced a predetermined distance from the sealing portion 14, as shown in FIG. 4. In this embodiment, it is more effective for the porous material layer 17 to be formed so as to be larger than the OEL unit 13. The distance between the first and second substrates 11 and 12, i.e., the distance L between the porous material layer 17 and the OEL unit 13 in the space region 10, is set to be large enough to prevent the Moire phenomenon, as described above. The distance between the first and second substrates 11 and 12 can be controlled using spacers 18 contained in the sealant 15 forming the sealing portion 14. The first substrate 11 and the OEL unit 13 are the same as in the embodiment described above, and thus descriptions thereof have not been repeated here.

FIG. 5 is a sectional view of an OELD according to another embodiment of the present invention. In this OELD, a barrier wall 19 is formed between the porous material layer 17 and the sealing portion 14 to prevent the color filter 20 and the porous material layer 17 from contacting the sealing portion 14. The distance between the first and second substrates 11 and 12, i.e., the distance L between the porous material layer 17 and the OEL unit 13, can be controlled by the barrier wall 19 to prevent the Moire phenomenon. The first and second substrates 11 and 12, the OEL unit 13, and the sealing portion 14 are the same as in the embodiment described above, and thus descriptions thereof have not been repeated here.

An OELD with a porous material layer according to the present invention provides the following effects.

First, the porous material layer, which remains transparent even after moisture absorption, can be applied easily to both a front emission display and a double-sided emission display, and allows a thinner display to be manufactured.

Second, due to the stacked structure of the color filter and the porous material layer, a full color OELD can be manufactured using simpler processes.

Third, the color filter or the porous material layer does not deteriorate the adhesion of the sealant and ensures a stable sealing structure.

Fourth, the porous material layer prevents intrusion of moisture as well as external air, thus extending the life span of the OELD.

While the present invention has been particularly shown and described with reference to exemplary embodiments thereof, it will be understood by those of ordinary skill in the art that various changes in form and details can be made therein without departing from the spirit and scope of the present invention as defined by the following claims.

1. An organic electroluminescent display comprising;
first and second substrates arranged opposite to each other and combined together;
an organic electroluminescent unit arranged between the first and second substrates and having a pair of opposing electrodes and an organic emissive layer adapted to emit light due to a recombination of electrons and holes supplied by the pair of opposing electrodes; and
a porous material layer disposed between the first and second substrates and adapted to absorb moisture, the porous material layer including a plurality of absorption holes and a porous material adapted to remain transparent after absorption of moisture.

2. The organic electroluminescent display of claim 1, wherein the porous material layer is arranged on a surface of the second substrate opposite to the first substrate.

3. The organic electroluminescent display of claim 2, further comprising a color filter is arranged on a surface of the porous material layer opposite to the first substrate.

4. The organic electroluminescent display of claim 1, further comprising a color filter is arranged on a surface of the second substrate opposite to the first substrate.

5. The organic electroluminescent display of claim 4, wherein the porous material layer is arranged on a surface of the color filter opposite to the first substrate.

6. The organic electroluminescent display of claim 1, wherein the porous material layer has a thickness ranging from 100 nm to 15 μm.

7. The organic electroluminescent display of claim 1, wherein the absorption holes of the porous material layer have a diameter ranging from 0.5 nm to 100 nm.

8. The organic electroluminescent display of claim 1, wherein an area of the porous material layer is equal to or greater than that of the organic electroluminescent unit.

9. The organic electroluminescent display of claim 1, wherein the second substrate comprises a glass substrate or a transparent plastic substrate.

10. The organic electroluminescent display of claim 9, further comprising a waterproof protective layer arranged on an internal surface of the plastic substrate.

11. The organic electroluminescent display of claim 9, wherein at least one of the opposing electrodes of the organic electroluminescent unit, arranged to face the second substrate, includes a transparent conducting agent.

12. The organic electroluminescent display of claim 1, further comprising a color filter interposed between the first and second substrates.

13. An organic electroluminescent display comprising;
first and second substrates arranged opposite to each other and combined together;
an organic electroluminescent unit arranged between the first and second substrates and having a pair of opposing electrodes and an organic emissive layer adapted to emit light due to a recombination of electrons and holes supplied by the pair of opposing electrodes;
a porous material layer disposed between the first and second substrates and adapted to absorb moisture, the porous material layer including a plurality of absorption holes and a porous material adapted to remain transparent after absorption of moisture; and
a color filter interposed between the first and second substrates.

14. The organic electroluminescent display of claim 13, wherein the porous material layer is arranged on a surface of the second substrate opposite to the first substrate.

15. The organic electroluminescent display of claim 14, wherein the color filter is arranged on a surface of the porous material layer opposite to the first substrate.

16. The organic electroluminescent display of claim 13, wherein the color filter is arranged on a surface of the second substrate opposite to the first substrate.

17. The organic electroluminescent display of claim 16, wherein the porous material layer is arranged on a surface of the color filter opposite to the first substrate.

18. The organic electroluminescent display of claim 13, wherein the porous material layer has a thickness ranging from 100 nm to 15 μm.

19. The organic electroluminescent display of claim 13, wherein the absorption holes of the porous material layer have a diameter ranging from 0.5 nm to 100 nm.

20. The organic electroluminescent display of claim 13, wherein an area of the porous material layer is equal to or greater than that of the organic electroluminescent unit.

21. The organic electroluminescent display of claim 13, wherein the second substrate comprises a glass substrate or a transparent plastic substrate.

22. The organic electroluminescent display of claim 21, further comprising a waterproof protective layer arranged on an internal surface of the plastic substrate.

23. The organic electroluminescent display of claim 21, wherein at least one of the opposing electrodes of the organic electroluminescent unit, arranged to face the second substrate, includes a transparent conducting agent.
